(19) United States
(12) Patent Application Publication
(10) Pub. No.: US 2009/0223973 A1
(43) Pub. Date: Sep. 10, 2009

(54) FUEL TANK APPARATUS

(75) Inventors: Hiromasa Suzuki, Aichi-ken (JP); Kazuyuki Tokuda, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/063,844

(22) PCT Filed: Aug. 29, 2006
(86) PCT No.: PCT/JP2006/317418

§ 371 Date: Feb. 14, 2008

(30) Foreign Application Priority Data
Sep. 7, 2005 (JP) 2005-259186

(51) Int. Cl. B65D 25/04; F16K 31/06

(52) U.S. Cl. 220/553; 137/544

(57) ABSTRACT

A fuel tank apparatus includes a sub-cup having a bottom portion and a side portion erected from said bottom portion and provided in a fuel tank and a suction filter arranged in a space surrounded by the side portion above the bottom portion and connected to a fuel pump. The side portion includes a partition wall partitioning the space into a main chamber in which the suction filter is arranged, and a sub-chamber. Maximum height H1 of the suction filter is higher than the height H2 of the partition wall. Because of such a structure, a fuel tank apparatus can be provided by which the fuel can reliably be supplied even when much water is retained in the tank.

### TECHNICAL FIELD

The present invention generally relates to a fuel tank apparatus and, more specifically, to a fuel tank apparatus having a sub-cup for holding fuel near a filter provided in the fuel tank.

### Background Art

In connection with a conventional fuel tank apparatus, Japanese Patent Laying-Open No. 07-148405 discloses a fuel filter aimed at suppressing wear of a filter caused by friction with a frame. In this reference, a fuel filter is arranged in a chamber provided in the fuel tank, and connected to a fuel pump through a suction pipe. When the fuel pump is driven, the fuel in the fuel tank is filtered by the fuel filter and thereafter fed to an engine through the suction pipe.

Further, Japanese Patent Laying-Open No. 2003-28019 discloses a fuel filter device aimed at improving oil/water separation function.

Water entering from a filler opening or moisture in the air condensed in the fuel tank may possibly be mixed in the fuel in the fuel tank. Therefore, the fuel tank disclosed in Japanese Patent Laying-Open No. 07-148405 has a fuel filter in order to prevent supply of the water mixed in the fuel to the engine.

Assume that a vehicle having the fuel tank mounted is kept stopped for a long period of time and the fuel and water are separated from each other. In that case, the fuel filter might possibly be submerged below the water level, if the amount of water mixed in the fuel were too large. In such a case, it becomes impossible to feed the fuel to the engine, and hence, the vehicle can not be re-started. Similar problem might occur in the fuel filter device disclosed in Japanese Patent Laying-Open No. 2003-28019.

### DISCLOSURE OF THE INVENTION

An object of the present invention is to prevent the above-described problem and to provide a fuel tank apparatus enabling more reliable fuel supply even when a large amount of water is retained in the tank.

The fuel tank apparatus in accordance with the present invention includes a container having a bottom portion and a side portion erected on the bottom portion and provided in a fuel tank and a fuel filter arranged in a space surrounded by the side portion above the bottom portion and connected to a fuel pump. Maximum height of the fuel filter is higher than the minimum height of the side portion.

In the fuel tank apparatus structured as described above, when the fuel and water are separated in the fuel tank, the water having relatively high density forms a lower layer and the fuel having relatively low density forms an upper layer. Here, even if the water should be retained in the container, the fuel at the upper portion of the container can be sucked in through the fuel filter to the fuel pump, as the fuel filter is formed to a position higher than the side portion of the container. Thus, the tolerable amount of water retention in the fuel tank can be increased, and the fuel in the fuel tank can more reliably be sucked in through the fuel filter.

The fuel tank apparatus further includes a tube for feeding part of the fuel emitted from the fuel pump through the fuel filter back to the fuel tank. The side portion includes a partition wall partitioning the space into a main chamber in which the fuel filter is arranged and a sub-chamber. In the sub-chamber, the fuel is fed from the fuel tank, by a negative pressure generated by the fuel flow in the tube. The fuel fed to the sub-chamber goes over the partition wall into the main chamber. Preferably, the maximum height of the fuel filter is higher than the height of the partition wall.

In the fuel tank apparatus structured as described above, even when water is retained in the main chamber of the container, the water that exceeds the height of the partition wall flows to the sub-chamber. Therefore, the level of water retained in the main chamber is not higher than the height of the partition wall. Accordingly, by arranging the fuel filter to a position higher than the partition wall, it becomes possible to suck in the fuel above the partition wall through the fuel filter to the fuel pump.

Preferably, the fuel filter is water-repellent. In the fuel tank apparatus structured as described above, the amount of water sucked in through the fuel filter can be reduced. Thus, the normal operation of the engine fed by the fuel becomes more reliable.

As described above, according to the present invention, a fuel tank apparatus can be provided that enables more reliable fuel supply even when a large amount of water is retained in the tank.

### BRIEF DESCRIPTION OF THE DRAWINGS

FIG. 1 is a cross-sectional view showing a fuel tank apparatus in accordance with Embodiment 1 of the present invention.

FIG. 2 is a cross-sectional view showing, in greater detail, the portion surrounded by two-dotted line II of FIG. 1.

FIG. 3 is a cross-sectional view of the fuel tank apparatus along the line III-III of FIG. 2.

FIG. 4 is a cross-sectional view of the fuel tank apparatus when the fuel pump is stopped.

FIG. 5 is a cross-sectional view showing a fuel tank apparatus in accordance with Embodiment 2 of the present invention.

### BEST MODES FOR CARRYING OUT THE INVENTION

Embodiments of the present invention will be described with reference to the figures. In the figures referred to in the following, the same or corresponding components are denoted by the same reference characters.

### Embodiment 1

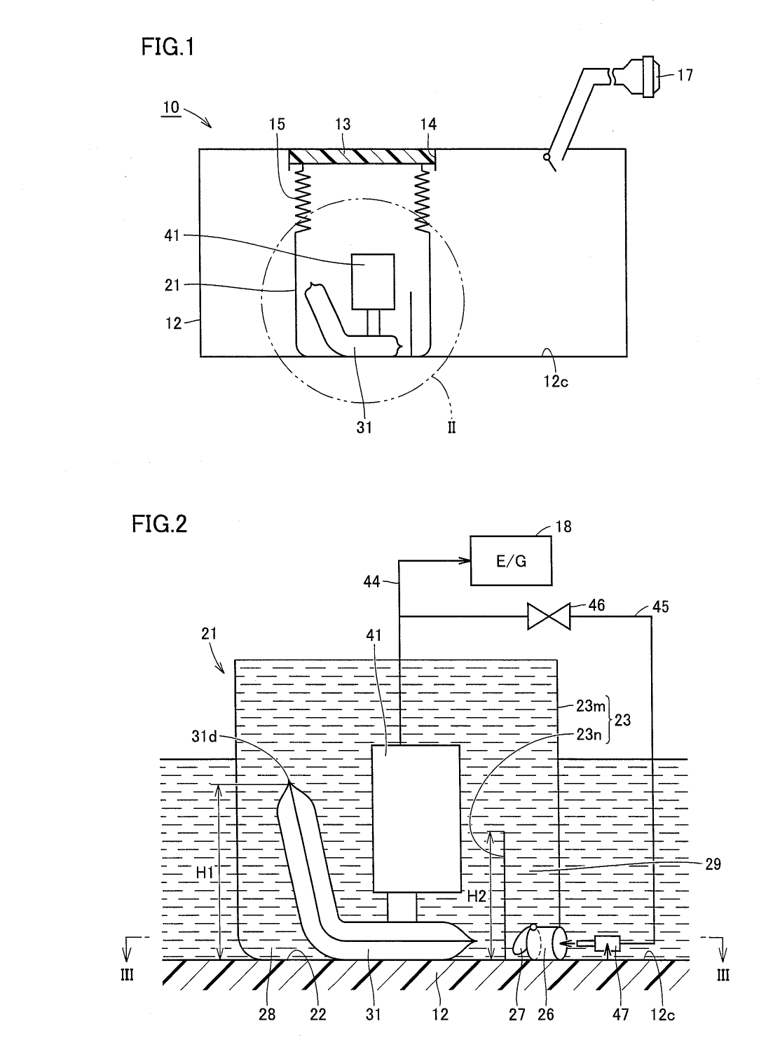

FIG. 1 is a cross-sectional view showing a fuel tank apparatus in accordance with Embodiment 1 of the present invention.

Referring to FIG. 1, a fuel tank apparatus 10 in accordance with the present embodiment is mounted on a vehicle, and supplies fuel to an engine as a power source of the vehicle.

Fuel tank apparatus includes: a fuel tank 12 having a bottom surface 12c and an opening 14; a sub-cup 21 inserted through opening 14 into fuel tank 12 and arranged on bottom surface 12c; and a suction filter 31 and a fuel pump 41 provided inside the sub-cup 21. Fuel tank 12 is formed of resin. Fuel tank 12 maybe formed of metal such as iron.

To fuel tank 12, a filler tube communicated with a filler inlet 17 for supplying fuel to the tank is connected. A lid 13 is provided on fuel tank 12 to close opening 14. Sub-cup 21 is connected to lid 13 with a spring 15 inserted therebetween. Sub-cup 21 is urged to bottom surface 12c by the elastic force of spring 15. Thus, sub-cup 21 follows deformation of fuel tank 12 and is always kept placed on bottom surface 12c.

The fuel in fuel tank 12 is first fed to sub-cup 21 and then sucked in by suction filter 31. Therefore, even when the vehicle is inclined with only a little fuel left in fuel tank 12 and the fuel is collected at one corner of the tank, the fuel that has been fed to sub-cup 21 can be held around suction filter 31. Therefore, air-suction by suction filter 31 can be prevented.

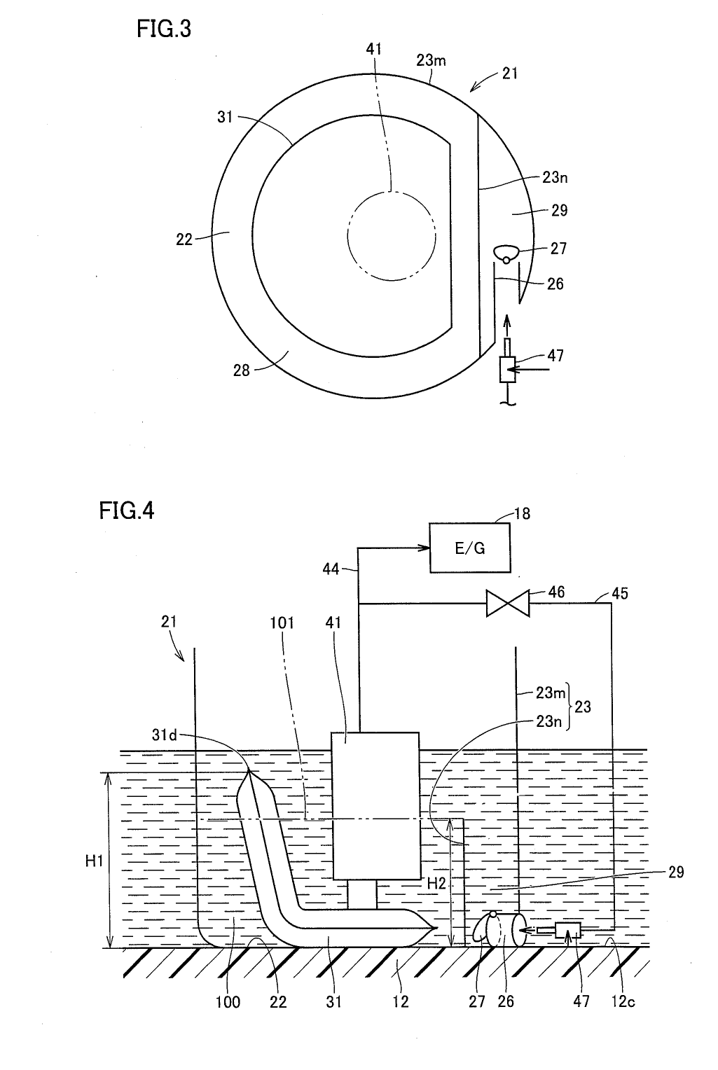

FIG. 2 is a cross-sectional view showing, in greater detail, the portion surrounded by two-dotted line II of FIG. 1. In the figure, the fuel tank apparatus when fuel pump 41 of FIG. 1 is in operation is depicted. FIG. 3 is a cross-sectional view of the fuel tank apparatus along the line III-III of FIG. 2.

Referring to FIGS. 2 and 3, sub-cup 21 is formed of a bottom portion 22 extending over bottom surface 12c, and a side portion 23 continuous from bottom portion 22. Side portion 23 includes a side wall 23m erected vertically upward from a circumferential edge of bottom portion 22 and forming a space above bottom portion 22, and a partition wall 23n erected vertically upward from the surface of bottom portion 22 and partitioning the space formed by sidewall 23m into a main chamber 28 and sub-chamber 29.

Partition wall 23n has a constant height H2. Height H2 refers to the length of partition wall 23n in the vertical direction measured from the bottom portion 22. Height H2 is lower than the height of sidewall 23m from the bottom portion 22, and it is the minimum height of side portion 23 from bottom portion 22.

Suction filter 31 is arranged on bottom portion 22 in main chamber 28. Suction filter 31 is formed to extend parallel to bottom portion 22 and then bent on bottom portion 22 in a direction apart from bottom portion 22. Suction filter 31 has a portion extending vertically upward from the bottom portion 22.

Suction filter 31 is formed of a water-repellent filter material having a contact angle with water of 90° or larger, such as polypropylene, polytetrafluoroethylene or polyethylene. Water may possibly be mixed in the fuel in fuel tank 12, as water may accidentally enter from filler inlet 17 of FIG. 1 at the time of filling, or moisture in the air in fuel tank 12 may be condensed. Suction filter 31 formed of water-repellent filter material suppresses supply of water to the engine.

In the present embodiment, suction filter 31 is formed by bending unwoven fabric of the material mentioned above and by heat-welding an end portion where the unwoven fabrics are overlapped. Suction filter 31 has a welded portion 31d where the unwoven fabrics are heat-welded. Suction filter 31 has a height H1. Height H1 represents length of suction filter 31 in the vertical direction measured from bottom portion 22. Height H1 represents the maximum height of suction filter 31 that can suck in the fuel, that is, the height of suction filter 31 except for the welded portion 31d. Suction filter 31 is formed such that height H1 becomes larger than height H2 of partition wall 23n. In the present embodiment, height H1 of suction filter 31 is lower than the height of sidewall 23m.

Here, bottom portion 22 as a reference position of measuring heights H1 and H2 extends in the horizontal direction for mounting on a vehicle. It is not limiting, and the heights H1 and H2 maybe measured each from the reference position of the same height.

To suction filter 31, fuel pump 41 is connected. Fuel pump 41 is positioned in main chamber 28. Fuel pump 41 is further connected through a fuel flow path 44 to engine 18.

Sub-cup 21 is provided with an inlet tube 26 for communication between sub-chamber 29 and the inside of fuel tank 12. Inlet tube 26 is arranged on bottom portion 22. At the position where inlet tube 26 opens into sub-chamber 29, a flapper valve 27, which can be opened/closed, is provided. Flapper valve 27 allows fuel flow from fuel tank 12 to sub-chamber 29, and regulates fuel flow from sub-chamber 29 to fuel tank 12.

Sealing of inlet tube 26 by flapper valve 27 is not very tight, and therefore, when fuel pump 41 is kept stopped for a long period of time, the fuel in sub-cup 21 moves through inlet tube 26 to fuel tank 12. Therefore, if the vehicle is kept parked for a long period of time in an inclined state with only a small amount of fuel left in fuel tank 12, suction filter 31 may possibly be exposed out of the fuel. in the present embodiment, however, suction filter 31 is arranged in main chamber 28 partitioned from inlet tube 26, and therefore, the fuel retained in main chamber 28 as the fuel used for starting the vehicle next time can reliably be held around suction filter 31.

At a position of fuel tank 12 adjacent to inlet tube 26, a jet pump 47 is arranged. Jet pump 47 is connected through a return flow path 45 to fuel flow path 44. On the passage of return flow path 45, a pressure regulator 46 is provided for maintaining constant the pressure of fuel fed to engine 18.

When fuel pump 41 is operated, the fuel fed through suction filter 31 to fuel flow path 44 is supplied to engine 18. Part of the fuel passing through fuel flow path 44 is fed through return flow path 45 to jet pump 47. At this time, because of the fuel flow through return flow path 45, a negative pressure generates in jet pump 47, and by the negative pressure, the fuel in fuel tank 12 is drawn into jet pump 47. The fuel is emitted from jet pump 47 to inlet tube 26, and enters sub-chamber 29. The fuel that exceeded the height of partition wall 23n of sub-chamber 29 flows into main chamber 28. The fuel pooled in this manner in main chamber 28 is sucked in by suction filter 31.

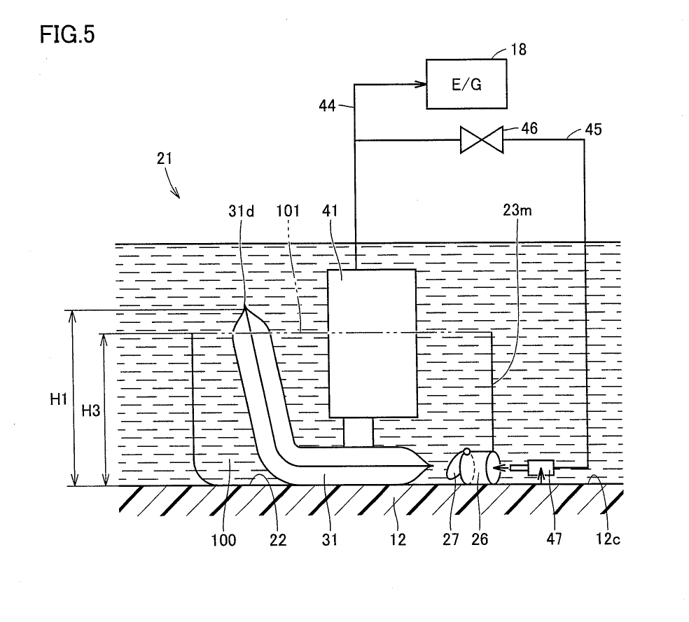

FIG. 4 is a cross-sectional view of the fuel tank apparatus when the fuel pump is stopped. Referring to FIG. 4, if the fuel pump is kept stopped for a long period of time, the fuel in sub-cup 21 gradually moves through inlet tube 26 to fuel tank 12, and therefore, the level of fuel in sub-cup 21 comes to be approximately equal to the level of fuel in fuel tank 12. On the other hand, in fuel tank 12, water that has been mixed in the fuel comes to be separated from the fuel, and the water forms a lower layer and the fuel forms an upper layer.

The fuel in fuel tank 12 is collected to main chamber 28 in sub-cup 21, and then, because of the water-repellent suction filter 31, supply to engine 18 is prevented. Therefore, if a large amount of water is mixed in the fuel, it follows that the amount of water 100 retained in main chamber 28 would be increased when the water is separated from the fuel. If the level 101 of water 100 exceeds the height of partition wall 23n, however, the water flows over partition wall 23n into sub-chamber 29, and further through inlet tube 26 to be retained on bottom surface 12c of fuel tank 12. Therefore, it is expected that, when the largest amount of water is retained in sub-cup 21, main chamber 28 is filled with water. In the present embodiment, suction filter 31 is formed to a position higher than partition wall 23n and, therefore, the fuel at a position higher than partition wall 23n can be sucked in through suction filter 31.

Fuel tank apparatus 10 in accordance with Embodiment 1 of the present invention includes sub-cup 21 as a container having bottom portion 22 and side portion 23 erected from bottom portion 22 and provided in fuel tank 12 and suction filter 31 as a fuel filter arranged in a space surrounded by side portion 23 above bottom portion 22 and connected to fuel pump 41. The maximum height H1 of suction filter 31 is higher than the minimum height H2 of side portion 23.

Fuel tank apparatus 10 further includes return flow path 45 as a pipe for returning part of the fuel emitted from fuel pump 41 through suction filter 31 back to fuel tank 12. Side portion 23 includes partition wall 23n partitioning the space into main chamber 28 in which suction filter 31 is arranged, and a sub-chamber 29 adjacent to main chamber 28. To sub-chamber 29, the fuel is fed from fuel tank 12, because of a negative pressures generated by the fuel flow in return flow path 45. The fuel fed to sub-chamber 29 flows over partition wall 23n into main chamber 28. The maximum height H1 of suction filter 31 is higher than the height H2 of partition wall 23n.

By fuel tank apparatus 10 in accordance with Embodiment 1 having the above-described structure, when engine 18 is to be started after the vehicle has been parked for a long period of time, the fuel can more reliably be supplied to engine 18. Thus, it is possible to start normal running of the vehicle without causing malfunction or failure of the engine.

Though an example in which fuel tank 12 has bottom surface 12c that extends flat has been described, fuel tank 12 may be formed in a saddle shape, to avoid a propeller shaft. Further, separate from return flow path 45 having pressure regulator 46 provided therein, a flow path branched from fuel flow path 44 may be provided, and jet pump 47 may be arranged in the flow path.

### Embodiment 2

FIG. 5 is a cross-sectional view showing a fuel tank apparatus in accordance with Embodiment 2 of the present invention. FIG. 5 corresponds to FIG. 4 of Embodiment 1. The fuel tank apparatus in accordance with the present embodiment basically has a similar structure as fuel tank apparatus 10 in accordance with Embodiment 1. In the following, description of overlapping components will not be repeated.

Referring to FIG. 5, in the present embodiment, partition wall 23n shown in FIG. 2 is not provided, and side portion 23 of Embodiment 1 includes sidewall 23m only. Sidewall 23m has a constant height H3. Height H3 represents length of sidewall 23m measured from bottom portion 22. Suction filter 31 is formed such that height H1 is higher than height H2 of sidewall 23m.

In the fuel tank apparatus of Embodiment 2 structured as described above, even when a large amount of water is mixed in the fuel in fuel tank 12 and sub-cup 21 should be filled with water, the fuel at a position higher than sub-cup 21 can be sucked in through suction filter 31. Thus, effects similar to those attained by Embodiment 1 can be attained.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention is mainly applicable to a fuel tank apparatus mounted on a vehicle and supplying fuel to an engine as a power source of the vehicle.

1-3. (canceled)

4. A fuel tank apparatus, comprising:
a container having a bottom portion and a side portion erected from said bottom portion and provided in a fuel tank;
a fuel filter arranged in a space surrounded by said side portion above said bottom portion and connected to a fuel pump; and
a tube for returning part of the fuel emitted from said fuel pump through said fuel filter back to said fuel tank; wherein
maximum height of said fuel filter is higher than minimum height of said side portion;
said side portion includes a partition wall partitioning said space into a main chamber in which said fuel filter is arranged, and a sub-chamber;
to said sub-chamber, the fuel is fed from said fuel tank because of a negative pressure generated by fuel flow in said tube, and the fuel fed to said sub-chamber flows over said partition wall into said main chamber; and
maximum height of said fuel filter is higher than the height of said partition wall.

5. A fuel tank apparatus, comprising:
a container having a bottom portion and a side portion erected from said bottom portion and provided in a fuel tank; and
a fuel filter arranged in a space surrounded by said side portion above said bottom portion and connected to a fuel pump; wherein
maximum height of said fuel filter is higher than minimum height of said side portion; and
said fuel filter is water-repellent.
